(19) United States
(12) Patent Application Publication
(10) Pub. No.: US 2015/0235796 A1
(43) Pub. Date: Aug. 20, 2015

(54) LIMITER TYPE BLOW OPEN AIR CIRCUIT BREAKER

(71) Applicant: General Electric Company, Schenectady, NY (US)

(72) Inventors: Saugata Das, Secunderabad (IN); Mahesh Jaywant Rane, Secunderabad (IN); Glen Charles Sisson, Wolcott, CT (US); Tanmay Tamboli, Secunderabad (IN)

(73) Assignee: General Electric Company, Schenectady, NY (US)

(21) Appl. No.: 14/185,068

(22) Filed: Feb. 20, 2014

(51) Int. Cl. H01H 73/02

(52) U.S. Cl. CPC H01H 73/02

(57) ABSTRACT

A circuit breaker and a method of forming a current limiting circuit breaker are described. The circuit breaker includes a carrier assembly to supply current to a circuit through a fixed contact in a first operative state, a movable contact in physical contact with the fixed contact of the circuit, and a contact arm coupled to the movable contact, the contact arm including a pivot point. The contact arm moves about the pivot point responsive to a force transferred as a result of a fault condition in the circuit and the movable contact breaks the physical contact with the fixed contact of the circuit to put the circuit breaker in a second operative state. The circuit breaker also includes a mechanism to move the carrier assembly to put the circuit breaker in a third operative state responsive to a signal indicative of the fault condition.

### BACKGROUND OF THE INVENTION

The subject matter disclosed herein relates to a current-limiting circuit breaker.

A circuit breaker is an automatically operated electrical switch that interrupts current flow when a fault is detected. This prevents an overload or short circuit that can damage the circuit being protected by the circuit breaker. Interruption of the current generates an arc which must be extinguished to prevent damage caused by the arc flash. In an air circuit breaker, the arc is broken by air (e.g., displaced air resulting from the contacts being moved into a closed chamber). The speed with which the arc is broken can affect the extent of damage. That is, a current limiting circuit breaker reduces the fault energy that flows into the circuit and, therefore, reduces any damage to the circuit caused by the fault.

### BRIEF DESCRIPTION OF THE INVENTION

According to one aspect of the invention, a circuit breaker includes a carrier assembly configured to supply current to a circuit through a fixed contact in a first operative state, the carrier assembly comprising a movable contact configured to be in physical contact with the fixed contact of the circuit to supply the current to the circuit in the first operative state; a contact arm coupled to the movable contact, the contact arm including a pivot point, the contact arm configured to move about the pivot point responsive to a force transferred as a result of a fault condition in the circuit and the movable contact configured to break the physical contact with the fixed contact of the circuit to put the circuit breaker in a second operative state responsive to movement of the contact arm; and a mechanism configured to move the carrier assembly to put the circuit breaker in a third operative state responsive to a signal indicative of the fault condition, wherein the movable contact of the carrier assembly is configured to break the physical contact with the fixed contact of the circuit to put the circuit breaker in the second operative state responsive to movement of the contact arm prior to the mechanism moving the carrier assembly to put the circuit breaker in the third operative state responsive to the signal.

According to another aspect of the invention, a current limiting assembly includes a movable contact configured to be in physical contact with a fixed contact in a first operative state; and a contact arm coupled to the movable contact, the contact arm including a pivot point, the contact arm configured to move about the pivot point responsive to a force transferred as a result of a fault condition in the circuit and the movable contact configured to break the physical contact with the fixed contact of the circuit to establish a second operative state responsive to movement of the contact arm.

According to yet another aspect of the invention, a method of developing a current limiting circuit breaker includes arranging a carrier assembly in physical contact with a circuit, the carrier assembly supplying current to the circuit through a fixed contact in a first operative state, the arranging the carrier assembly further comprising arranging a movable contact to be in physical contact with the fixed contact of the circuit in the first operative state arranging a contact arm to be coupled to the movable contact, the contact arm including a pivot point, the contact arm configured to move about the pivot point responsive to a force transferred as a result of a fault condition in the circuit and the movable contact configured to break the physical contact with the fixed contact of the circuit to put the circuit breaker in a second operative state responsive to movement of the contact arm; and arranging a mechanism coupled to the carrier assembly, the mechanism configured to move the carrier assembly to put the circuit breaker in a third operative state responsive to a signal indicative of the fault condition. These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 details a circuit breaker according to an embodiment of the invention;

FIG. 2 depicts the circuit breaker according to the embodiment shown in FIG. 1;

FIG. 3 depicts the circuit breaker according to the embodiment shown in FIG. 1;

FIG. 4 is a three-dimensional view of the circuit breaker according to an embodiment of the invention;

FIG. 5 details the cam assembly according to an embodiment of the invention;

FIG. 6 details the arrangement of the cam assembly and the latching bracket assembly according to an embodiment of the invention;

FIG. 7 depicts aspects of the carrier assembly according to an embodiment of the invention;

FIG. 8 depicts aspects of the carrier assembly according to an embodiment of the invention;

FIG. 9 details a restrike control latch assembly according to an embodiment of the invention;

FIG. 10 provides an exploded view of a restrike control latch assembly according to an embodiment of the invention; and

FIG. 11 details the arrangement of the restrike control latch assembly and the latching bracket assembly according to an embodiment of the invention.

The detailed description explains embodiments of the invention, together with advantages and features, by way of example with reference to the drawings.

### DETAILED DESCRIPTION OF THE INVENTION

As noted above, speed of operation of a circuit breaker is a key factor in limiting fault energy. Typically, a circuit breaker includes a trip mechanism that receives a fault signal and initiates operation of a carrier assembly that resides between the trip mechanism and the circuit to be protected. The operation of the carrier assembly by the trip mechanism creates the open condition in which current flow to the circuit is interrupted. Embodiments of the system and method described herein relate to a carrier assembly that additionally operates based on a force generated by the fault current. Specifically, the moving arm associated with the moving contact initiates the break in contact based on the force.

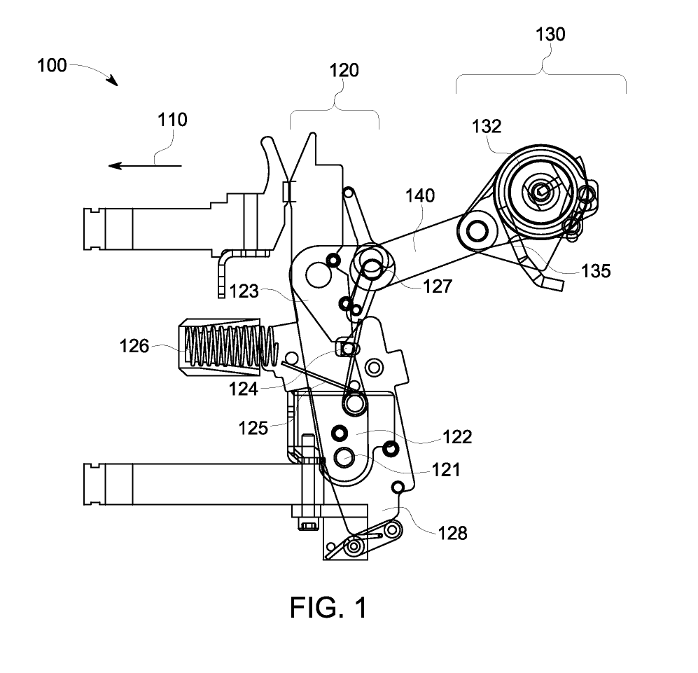

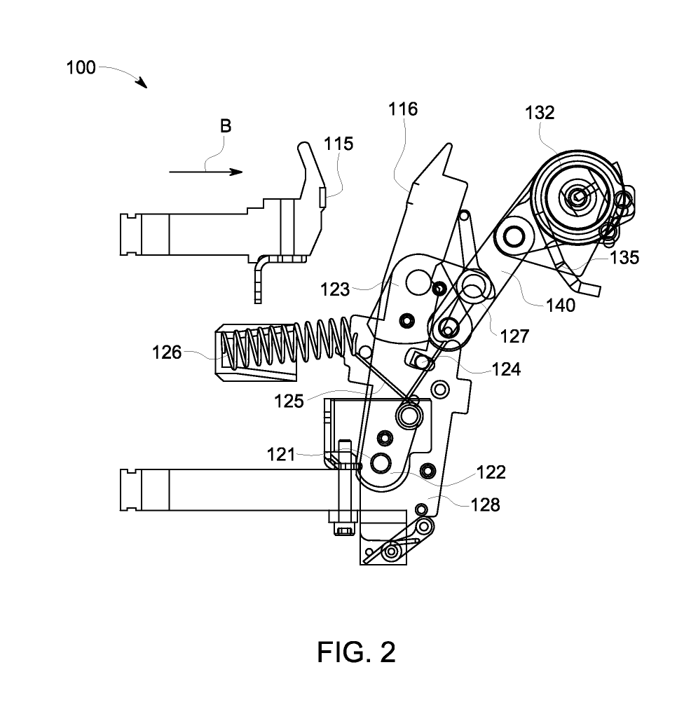

FIG. 1 details a circuit breaker 100 according to an embodiment of the invention. The view shown in FIG. 1 is a perspective side view showing one set of contacts. As shown in FIG. 1, the circuit breaker 100 is in a closed (“on”) position such that current is flowing to the circuit 110. Based on a fault, the carrier assembly 120 between the circuit 110 and the mechanism 130 physically disengages from the circuit 110, thereby disengaging the fixed contact 115 (FIG. 2) of the circuit 110 from the moving contact 116 (FIG. 2) of the carrier assembly 120. The mechanism 130 receives a signal based on a fault condition being detected and pulls the carrier assembly 120 away from the circuit 110 to fully disengage contact between the circuit 110 and the carrier assembly 120. The mechanism 130 and the carrier assembly 120 are connected via a pole coupler 140 which ends at the mechanism 130 in a lay shaft 132 and at the carrier assembly 120 at a pole coupler pin 127. The mechanism 130 facilitates resetting the circuit breaker 100 (back to the position shown in FIG. 1) following a fault detection and clearing procedure. The mechanism spring 135 facilitates this full opening. In a conventional selective circuit breaker, the mechanism 130 is the only initiator of a break in contact between the circuit 110 and the carrier assembly 120. According to the embodiment shown in FIG. 1, the carrier assembly 120 disengages from the circuit 110 in less time than it takes for the mechanism 130 alone to break the contact, as detailed below. That is, the carrier assembly 120 breaks the contact to limit the flow of fault current and, subsequently, the mechanism 130 fully disengages the carrier assembly 120 in preparation for reset. The carrier assembly includes a contact arm 122 that includes the moving contact 116. The contact arm 122 shares a pivot point (contact arm and carrier assembly pivot 121) with the carrier assembly 120. A latch pin 124 keeps the cam assembly 123 within the latching bracket assembly 128 locked in position. The latch pin 124 is a spring-loaded pin that operates based on the latch spring 125.

FIG. 2 depicts the circuit breaker 100 according to the embodiment shown in FIG. 1. In FIG. 2, the contact between the circuit 110 and the carrier assembly 120 is broken (as indicated by “A”). This break (A) is caused by the force exerted in the direction B by the fault current. Thus, the carrier assembly 120 is said to be in the blow open position in FIG. 2. The moving contact 116 of the carrier assembly 120 is pushed away from the fixed contact 115 by the fault current force (B) in the following way. The force from the fault current pushes against the moving contact 116. Because the contact arm 122 and the carrier assembly 120 share a pivot point (contact arm and carrier assembly pivot 121) that is as far as possible from the point of contact between the fixed contact 115 and the moving contact 116 (on the opposite end of the contact arm 122), torque acting on the contact arm 122 due to the fault force is maximized. As a result, when a fault occurs, the fault current exerts a force (B) pushing away the moving contact 116, and the carrier assembly 120 pulls away from the circuit 110 by pivoting at the contact arm and carrier assembly pivot 121. In alternate embodiments, the pivot of the contact arm 122 may be different from the pivot of the carrier assembly 120 but the fault force would affect movement at both pivots. Rotation of the contact arm 122 about the contact arm and carrier assembly pivot 121 based on the fault force pushes the latch pin 124. The latch pin 124 is a spring-loaded pin in the illustrated embodiment. The latch pin 124 may be activated based on one or multiple contact arms 122. Movement of the latch pin 124 de-latches the cam assembly 123, which facilitates further movement of the carrier assembly 120 away from the circuit 110. A comparison of the circuit breaker 100 in FIG. 1 (which is in the closed position) with the circuit breaker 100 in FIG. 2 (which is in the blow open position) indicates that the carrier assembly spring 126 is in the compressed state when the circuit breaker 100 is in the closed position and in the stretched state when the circuit breaker 100 is in the open position.

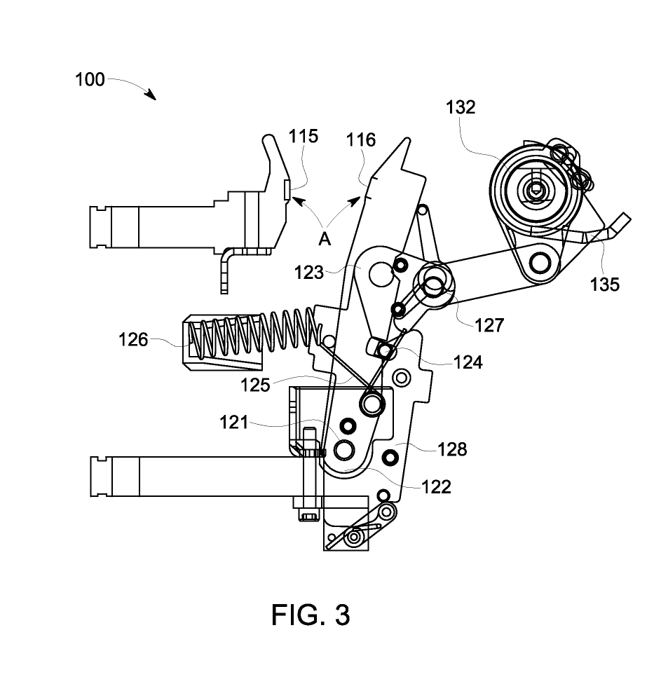

FIG. 3 depicts the circuit breaker 100 according to the embodiment shown in FIG. 1. In FIG. 3, the carrier assembly 120 is in the open position in which it may be reset by the mechanism 130. As a comparison of FIG. 2 (showing the circuit breaker 100 in the blow open position) with FIG. 3 (showing the circuit breaker 100 in the open position) indicates, the mechanism spring 135 around the lay shaft 132 aids in putting the carrier assembly 120, which is already in the blow open position (FIG. 2), into the open position. Specifically, the pole coupler 140 is positioned for a reset of the circuit breaker 100. To be clear, the fixed contact 115 and moving contact 116 disengage, thereby limiting fault current, prior to action by the mechanism 130. The disengagement is based on the configuration of the carrier assembly 120 as discussed with reference to FIG. 2 above. However, in order for the mechanism 130 to be able to reset the circuit breaker 100, the mechanism 130 must put the carrier assembly 120 in a fully disengaged position (referred to as the open position here). From the position shown in FIG. 3, the mechanism 130 may use the pole coupler 140 to put the circuit breaker 100 back in the closed position shown in FIG. 1.

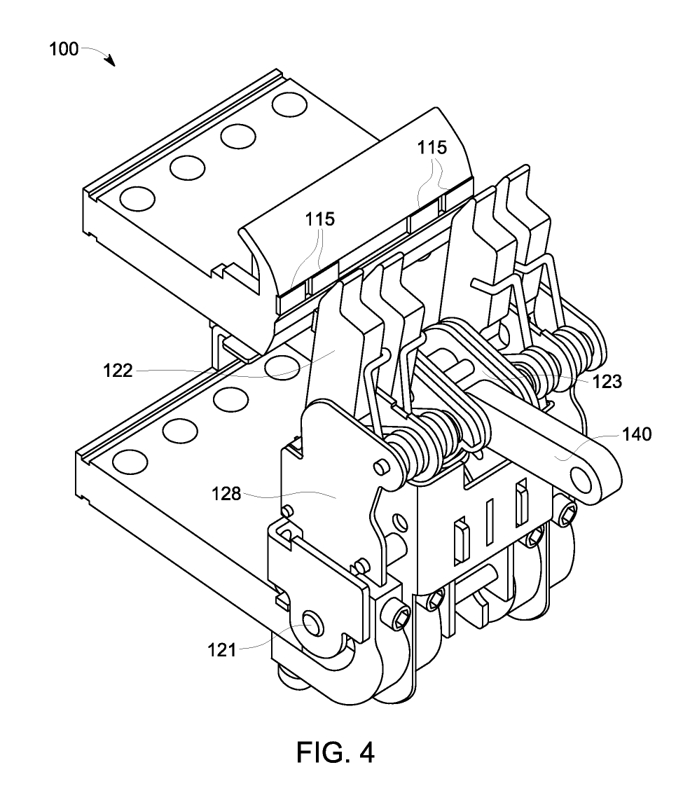

FIG. 4 is a three-dimensional view of the circuit breaker 100 according to an embodiment of the invention. As FIG. 4 makes clear, multiple sets of contacts (fixed contact 115 and moving contact 116) may be affected with the carrier assembly 120. A plurality of contact arms 122 correspond with the moving contacts 116. While the exemplary circuit breaker 100 shown in FIG. 4 includes four fixed contacts 115, the circuit breaker 100 according to embodiments of the invention is not limited to any particular number and may have one, eight, or another number of fixed contacts 115, for example.

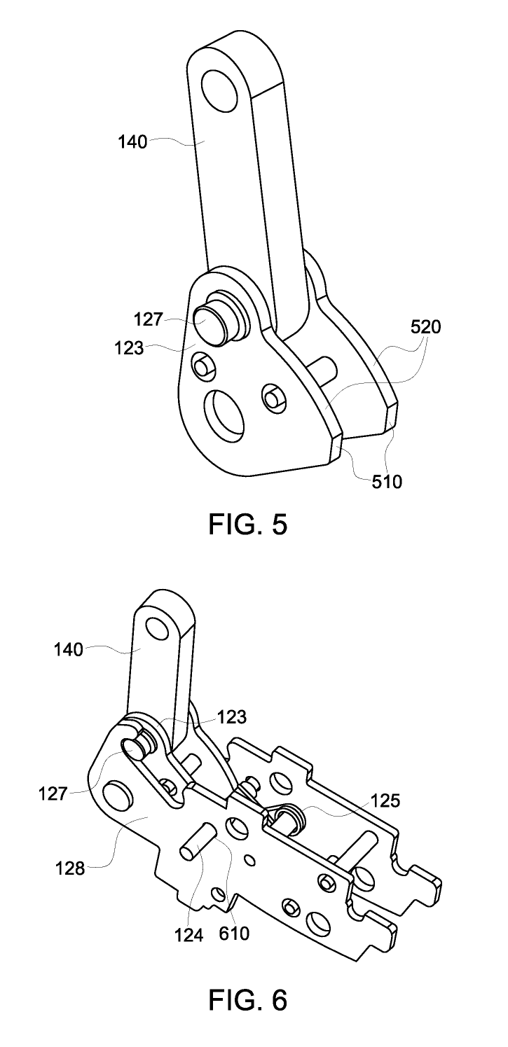

FIG. 5 details the cam assembly 123 according to an embodiment of the invention. The latch surface 510 indicates the portion of the cam assembly 123 that contacts the latch pin 124 when the circuit breaker 100 is in the closed position. The de-latch surface 520 indicates the portion of the cam assembly 123 that contacts the latch pin 124 when the circuit breaker 100 is in the blow open position. When the force of the fault moves the moving contact 116 based on a pivot at the contact arm and carrier assembly pivot 121, the latch pin 124 moves from the latch surface 510 of the cam assembly 123 to the de-latch surface 520 to rotate the cam assembly 123 about the pole coupler pin 127 and further dissociate the moving contacts 116 from the fixed contacts 115.

FIG. 6 details the arrangement of the cam assembly 123 and the latching bracket assembly 128 according to an embodiment of the invention. As shown in FIG. 6, the pole coupler pin 127 is held by the latching bracket assembly 128 and goes through the cam assembly 123 such that the cam assembly 123 may rotate about the pole coupler pin 127 once the latch pin 124 moves to de-latch the cam assembly 123. The latch pin 124 need not necessarily have a cylindrical surface and need not necessarily slide along a slot 610. In alternate embodiments, the latch pin 124 may be pivoted in circular holes instead of slots 610 and may rotate instead of sliding. In addition, the exemplary latch pin 124 is shown as being spring-mounted based on a torsion spring (latch spring 125). In alternate embodiments, the latch pin 124 may be operated based on a different type of spring such as a tension spring, for example. The interface surfaces of the cam assembly 123, the latch pin 124, and the slot 610 may be provided with a heat treatment or surface finish or with bearing parts that minimize friction and facilitate smooth operation of the carrier assembly 120.

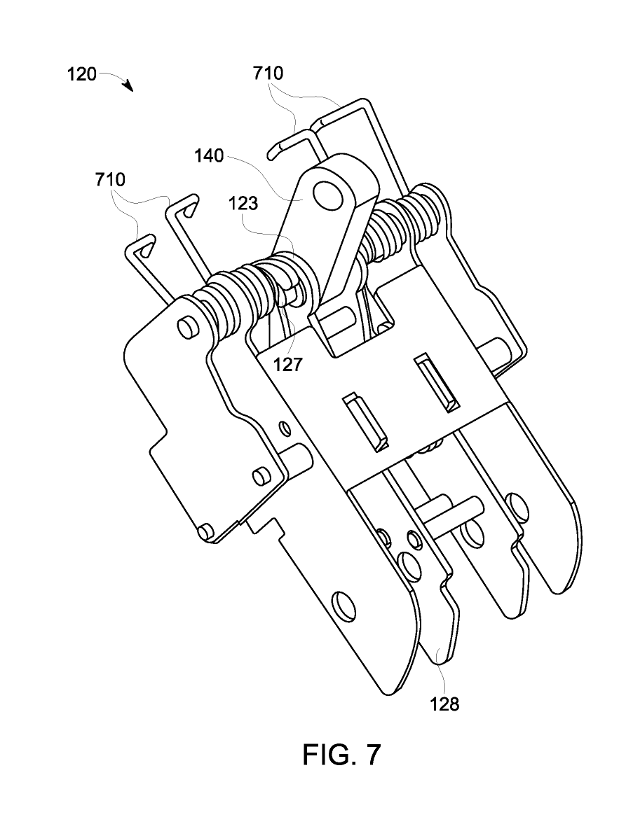

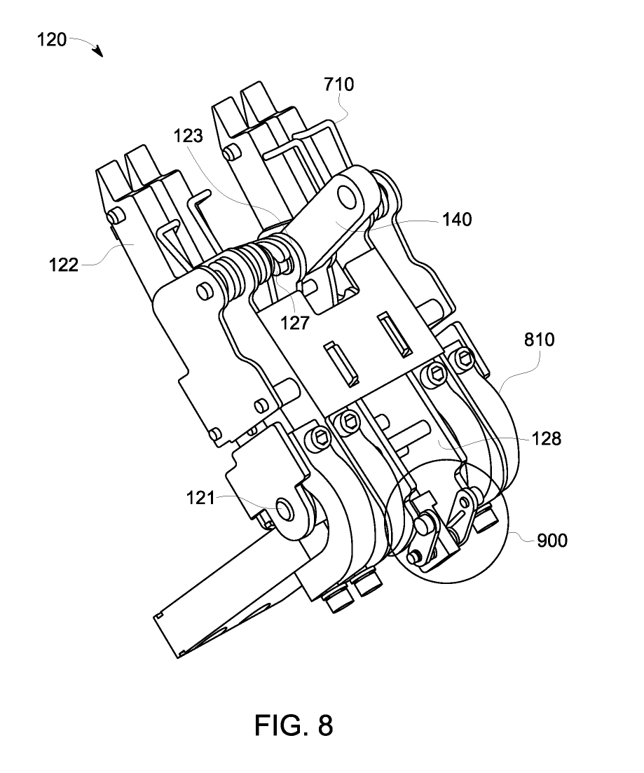

FIG. 7 depicts aspects of the carrier assembly 120 according to an embodiment of the invention. FIG. 7 shows contact springs 710. While shown as torsion springs in FIG. 7, the contact springs 710 may be extension, compression, or leaf springs in alternate embodiments. FIG. 8 depicts aspects of the carrier assembly 120 according to an embodiment of the invention. FIG. 8 shows a flexible component 810 which may be connected below the contact arms 122 in alternate embodiments. FIG. 8 also includes the contact arms 122 and shows the contact springs 710 resting on the contact arms 122. While the latching bracket assembly 128 is shown between the contact arms 122, in alternate embodiments of the invention, the latching bracket assembly 128 may be arranged on the sides of the set of contact arms 122, for example. FIG. 8 also shows a restrike control latch assembly 900 at an opposite end of the latching bracket assembly 128 from the cam assembly 123.

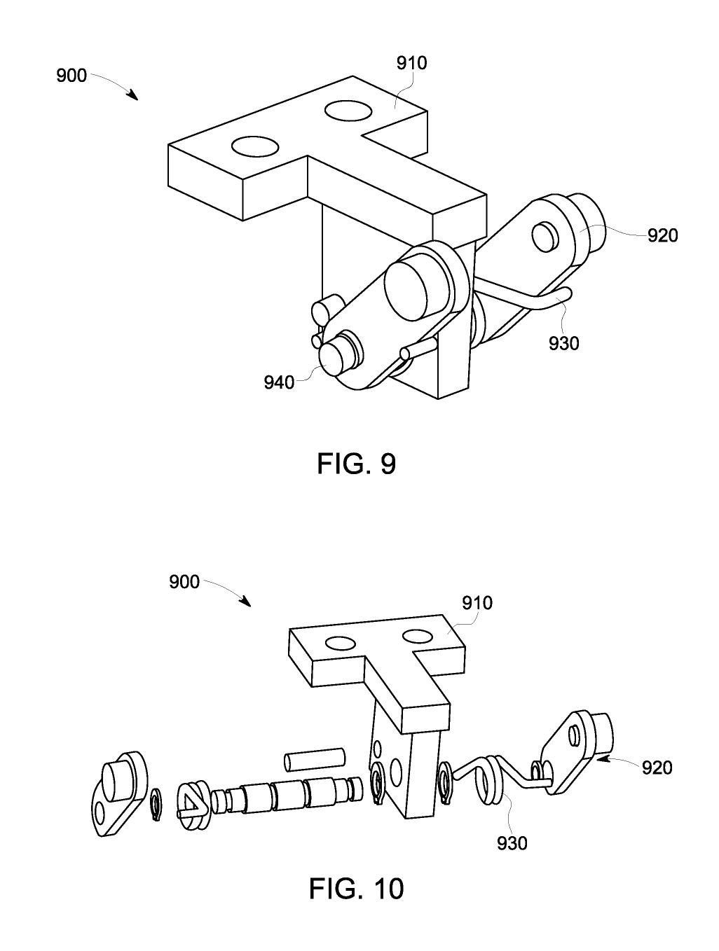

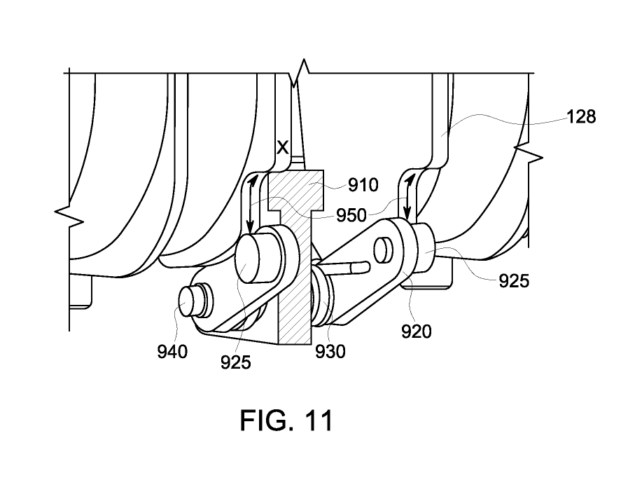

FIG. 9 details a restrike control latch assembly 900 according to an embodiment of the invention. The restrike control latching assembly 900 includes fixing bracket 910 to attach the restrike control latching assembly 900 to the bottom terminal (see e.g., FIG. 4). The restrike control latching assembly 900 also includes a latch link assembly 920 with a latch link pin 925, a biasing torsion spring 930, and latch link assembly pivot pin 940. FIG. 10 provides an exploded view of a restrike control latch assembly 900 according to an embodiment of the invention. FIG. 11 details the arrangement of the restrike control latch assembly 900 and the latching bracket assembly 128 according to an embodiment of the invention. The latch link pin 925 forms a cam-follower joint with the latching bracket surface 950 of the latching bracket assembly 128 such that the latch link pin 925 follows the latching bracket surface 950 and is always in touch with the surface 950. When the carrier assembly 120 is pushed away from the circuit 110 based on a fault force and is about to re-bounce after hitting the bottom terminal (FIG. 4), the latch link pin 925 slides along the dented area of the latching bracket surface 950 (ending up near “x”). After impact of the carrier assembly 120 with the bottom terminal (FIG. 4), the carrier assembly 120 rotates in the opposite direction (back toward the circuit 110) but faces an opposing force from the biasing torsion spring 930 to overcome the dented area of the latching bracket surface 950. As a result, bounce-back of the carrier assembly 120 into contact with the circuit 110 is restricted to prevent restrike of the electric arc. During the closing operation, the mechanism 130 supplies sufficient energy to overcome the force of the biasing torsion spring 930.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A circuit breaker, comprising:
a carrier assembly configured to supply current to a circuit through a fixed contact in a first operative state, the carrier assembly comprising,
a movable contact configured to be in physical contact with the fixed contact of the circuit to supply the current to the circuit in the first operative state;
a contact arm coupled to the movable contact, the contact arm including a pivot point, the contact arm configured to move about the pivot point responsive to a force transferred as a result of a fault condition in the circuit and the movable contact configured to break the physical contact with the fixed contact of the circuit to put the circuit breaker in a second operative state responsive to movement of the contact arm; and
a mechanism configured to move the carrier assembly to put the circuit breaker in a third operative state responsive to a signal indicative of the fault condition, wherein
the movable contact of the carrier assembly is configured to break the physical contact with the fixed contact of the circuit to put the circuit breaker in the second operative state responsive to movement of the contact arm prior to the mechanism moving the carrier assembly to put the circuit breaker in the third operative state responsive to the signal.

2. The circuit breaker according to claim 1, further comprising a pole coupler configured to connect the mechanism to the carrier assembly.

3. The circuit breaker according to claim 2, wherein the mechanism further comprises a spring configured to move the pole coupler to put the circuit breaker in the third operative state after the carrier assembly is physically disengaged from the fixed contact in the second operative state.

4. The circuit breaker according to claim 1, wherein the carrier assembly further comprises a latch pin configured to move responsive to a movement of the contact arm and to de-latch a cam assembly.

5. The circuit breaker according to claim 4, wherein a distance between the fixed contact and the movable contact increases based on de-latching the cam assembly by the latch pin.

6. The circuit breaker according to claim 4, wherein the latch pin is spring-loaded.

7. The circuit breaker according to claim 4, wherein the cam assembly is arranged in a center of a plurality of the contact arms.

8. The circuit breaker according to claim 1, wherein the carrier assembly further comprises a restrike control assembly configured to prevent bounce-back of the carrier assembly to a position in the first operative state in which the fixed contact and the movable contact are in physical contact.

9. The circuit breaker according to claim 8, wherein the restrike control assembly includes a spring configured to provide an opposing force to the carrier assembly when the carrier assembly is in a bounce-back state in which the carrier assembly is moving back toward the circuit.

10. A current limiting assembly, the assembly comprising:
a movable contact configured to be in physical contact with a fixed contact in a first operative state; and
a contact arm coupled to the movable contact, the contact arm including a pivot point, the contact arm configured to move about the pivot point responsive to a force transferred as a result of a fault condition in the circuit and the movable contact configured to break the physical contact with the fixed contact of the circuit to establish a second operative state responsive to movement of the contact arm.

11. The assembly according to claim 10, further comprising a pole coupler configured to connect the assembly to a mechanism.

12. The assembly according to claim 11, wherein the pole coupler is configured to reset the assembly to the first operative state responsive to the mechanism.

13. The assembly according to claim 10, further comprising a latch pin and a cam assembly, the latch pin configured to move responsive to movement of the contact arm and de-latch the cam assembly.

14. The assembly according to claim 13, wherein a distance between the fixed contact and the moving contact increases responsive to the latch pin de-latching the cam assembly.

15. The assembly according to claim 13, wherein the latch pin is spring-loaded.

16. The assembly according to claim 13, wherein the cam assembly is arranged in a center of a plurality of the contact arms.

17. The assembly according to claim 10, further comprising a restrike control assembly configured to prevent bounce-back to the first operative state in which the fixed contact is in physical contact with the movable contact.

18. The assembly according to claim 17, wherein the restrike control assembly includes a spring configured to provide an opposing force to the assembly when the assembly is in a bounce-back state in which the assembly is moving back toward the circuit.

19. A method of developing a current limiting circuit breaker, the method comprising:
arranging a carrier assembly in physical contact with a circuit, the carrier assembly supplying current to the circuit through a fixed contact in a first operative state, the arranging the carrier assembly further comprising,
arranging a movable contact to be in physical contact with the fixed contact of the circuit in the first operative state
arranging a contact arm to be coupled to the movable contact, the contact arm including a pivot point, the contact arm configured to move about the pivot point responsive to a force transferred as a result of a fault condition in the circuit and the movable contact configured to break the physical contact with the fixed contact of the circuit to put the circuit breaker in a second operative state responsive to movement of the contact arm; and
arranging a mechanism coupled to the carrier assembly, the mechanism configured to move the carrier assembly to put the circuit breaker in a third operative state responsive to a signal indicative of the fault condition.

20. The method according to claim 19, further comprising arranging a restrike control assembly to prevent bounce-back of the carrier assembly to the first operative state.
